(19) United States
(12) Patent Application Publication
(10) Pub. No.: US 2009/0013050 A1
(43) Pub. Date: Jan. 8, 2009

(54) Systems and Methods for Information Delivery

(76) Inventor: Giovanni Giunta, Pretoria (ZA)

Correspondence Address: HAHN AND MOODLEY, LLP, P.O. BOX 52050, MINNEAPOLIS, MN, 55402, US

(21) Appl. No.: 12/096,023

(22) PCT Filed: Nov. 16, 2006
(86) PCT No.: PCT/ZA2006/000130

§ 371 Date: Sep. 2, 2008

Related U.S. Application Data
(60) Provisional application No. 60/742,842, filed on Dec. 6, 2005.

(51) Int. Cl. G06F 15/16

(52) U.S. Cl. 709/206

(57) ABSTRACT

Provided is a computer system 26 and associated methods for information delivery across a communications network 38, such as the Internet. The computer system 26 includes a memory arrangement 28, a processor 30, a display 44, and a transceiver 32 for managing input and output ports 34 and 36. The processor 30 is configured to execute the specific instructions stored in the memory arrangement 28 in order to automatically determine when a user sends an e-mail from the computer system 26. The processor also executes specific instructions to electronically prompt the user to specify a delivery method for such e-mail before said e-mail is sent via the communications network 38, to relay the e-mail together with identifying information to a particular central server 40 and/or 42 on the communications network via a specific dedicated network access port 34 of the computer not associated with a conventional e-mail delivery access port 36 of the computer if the user specifies such delivery. Otherwise, if the user specifies conventional e-mail delivery, the processor 30 relays the e-mail to the conventional e-mail delivery port 36 of the computer

### FIELD OF THE INVENTION

This invention relates to systems and associated methods for information delivery across a communications network.

### BACKGROUND TO THE INVENTION

In general, the Internet is used primarily to send and receive e-mail messages and to access website content and related information hosted by computer servers connected to the Internet.

In order to use e-mail communication, a user requires an e-mail address, and an e-mail client or e-mail application to send and retrieve such e-mail messages. E-mail clients are typically either an e-mail application installed on a user's computer, or offered as a web based service accessible from a web browser.

An e-mail address is a unique electronic address, such as “john@yahoo.com”, which allows users who have e-mail addresses to communicate with each other using e-mail software. The unique e-mail address is necessary to route sent e-mails to the correct recipient via the Internet by directing the e-mail through a number of e-mail servers. In general, most e-mail systems typically consist of two different servers running on a server machine, with these server machines then spread throughout the Internet retrieving and sending e-mails from different e-mail domains.

One type of server is generally referred to as the SMTP (Simple Mail Transfer Protocol) Server, which handles outgoing mail. Another type of server is called the POP3 (Post Office Protocol 3) Server, which handles incoming mail. The SMTP server generally monitors or “listens” on port number 25 of the server machine or computer, while the POP3 server most commonly monitors port 110 of a computer.

Whenever a sender sends an e-mail, the sender's e-mail application or e-mail client interacts with the SMTP server to handle the sending or transmitting of said e-mail. The SMTP server connection to sender's mail application is typically arranged by the senders Internet Service Provider, which provides the sender Internet and e-mail access. This SMTP server communicates with other SMTP servers to actually delivery the e-mail message via the Internet, or the like.

A problem with the existing technology is with the increase in “spam” or unsolicited e-mail messages and the subsequent increased e-mail security and use of e-mail firewalls, and the like. Under these circumstances, it has become increasingly difficult to send and receive e-mails, or to ensure that a desired recipient has received your e-mail message, especially when this message needs to be delivered with urgency.

In addition, there are generally also certain software filters and monitors on e-mail servers which monitor the content of e-mail messages. As a result of this filtering or monitoring of content, the delivery time of certain e-mails containing such things as images, imbedded HTML content and/or attachments are sometimes delayed and could take anywhere from a few minutes to a few hours to deliver or pass through the filtering process. Also, certain mail servers are configured to block certain content in e-mail messages, resulting in the recipient never receiving the intended message.

An example of the above generally occurs where employers institute strict filtering techniques on mail servers to restrict employees from abusing a company's e-mail facilities, or the like.

Similarly, to use the Internet to search a particular website or view similar Internet content, a user typically requires a web browser, like the widely used Microsoft™ Internet Explorer™, Netscape Navigator™, Opera™, Mozilla™ Firefox™, or similar software Internet browsers. In general, an address bar is provided in a browser where a user can type in a specific URL (Uniform Resource Locator) address which will open the website registered to this particular web address, e.g. www.uspto.gov, or the like.

Web site addresses are called domains which are generally registered or owned by certain companies or organizations which display website information on the Internet. When a user types in a website domain or website address in the web browser's address bar, e.g. www.ford.com, the browser locates the domain name and opens the website onto the user's browser viewing window. In general, a website address takes the user to the website's home page, where the user is then able to search within the website for specific content of interest.

While all content within a specific website has the same web address or URL as the home page, such content will include additional extensions to this URL in order to further distinguish them from the main or home page, e.g. www.ford.com/vehicles/f350/specification/info.htm, or the like. These are typically difficult to remember, and when a web user wants to return to a page containing specific information in which said user is interested in, they would typically return to the main or home page and is then required to navigate to the specific page of interest. It would therefore be beneficial to allow a consumer to identify the exact information within a website he/she would like to access and then allow the consumer the ability to access these pages directly, without having to search or navigate through a particular website to locate the webpages of interest, resulting in time savings and simplicity.

In summary, e-mails have become an ordinary part of daily life for many, if not most first world resident people across the world. It provides an efficient and convenient way of communication. However, due to widespread occurrences of computer viruses and unsolicited communications (spam), many e-mail servers include filter applications and/or firewall software for filtering or blocking suspect e-mails from intended recipients. This often prevents people from receiving specific information which they have requested due to over zealous filtering.

For example, US patent publication no. 2004/0267638 and South African patent no. 2004/7524 provides for a system which enables a user to request particular website information using an e-mail request so that the requested website information is delivered as an e-mail to that user's e-mail application.

A further problem associated with the delivery of e-mail messages is that they are frequently delayed due to inherent processes involved in the relaying of such messages by e-mail servers. As a result, requested information may be subject to delay.

A still further problem associated with e-mail applications used for viewing website information is that such an e-mail application is typically not set up to view the requested content in a preferred format.

This invention proposes a possible solution to the above-mentioned problems.

### SUMMARY OF THE INVENTION

According to a first aspect of the invention there is provided a computer system for information delivery, which computer system includes

a memory arrangement for storing specific instructions;

a processor arranged in communication with said memory arrangement which processor executes the specific instructions in order to automatically determine when a user sends an e-mail from the computer, to electronically prompt the user to specify a delivery method for such e-mail before said e-mail is sent via a communications network, to relay the e-mail together with identifying information to a particular central server on the communications network via a specific dedicated network access port of the computer not associated with a conventional e-mail delivery access port of the computer if the user specifies such delivery, or to relay the e-mail via a conventional e-mail delivery port of the computer if such delivery is specified, to receive information uniquely pre-associated with the relayed e-mail via the dedicated network access port, and to format the received information into a suitable format for delivery into an e-mail inbox of the computer; and

a suitable transceiver with which the processor is able to relay and receive data via the communications network, so that the information associated with the address is requestable and/or deliverable as an e-mail independent from the conventional e-mail delivery port of the computer.

It is to be appreciated that the conventional e-mail delivery ports of a computer are generally subject to different filters than other network access ports of a computer, i.e. an Internet access port generally uses a different protocol to send and receive information. For example, a typical e-mail protocol is POP3 (Post Office Protocol 3) or SMTP (Simple Mail Transfer Protocol), and a typical Internet protocol is HTTP (Hyper Text Transfer Protocol), FTP (File Transfer Protocol), or the like.

Accordingly, by being able to send and receive information via e-mails independently of filtered and/or firewalled access ports ensures that requested information reaches an intended recipient, whilst simultaneously incorporating the efficiency and functionality of e-mail.

The processor may prompt the user to specify a delivery method by displaying a suitable prompt on a display of the computer which enables the user to choose an option, or the like.

It is to be appreciated that the e-mail is generally addressed to a particular address which is uniquely associated with specific information in which the user is interested. The specific information is typically information hosted on a website, or the like, e.g. a specific website for a particular product, or the like. As such, it is to be appreciated that the specific information is retrievable using an e-mail rather than the user having to access a site where such information is hosted.

The identifying information may include locating information which allows the computer to be located on the communications network, i.e. an e-mail address, an IP (Internet Portal) address, or the like. It is to be appreciated that the locating information allows a server to send the computer the requested information via the communications network.

The identifying information may include a specific electronic address uniquely associated with specific information on the communications network, e.g. an e-mail address, an IP address, and/or the like. As such, the specific electronic address may be that of the particular central server to which the e-mail and identifying information is relayed to, e.g. a return e-mail address, or the like.

The identifying information may include a code able to identify the user sending the e-mail, e.g. personal particulars, or the like. The code may be used for research purposes, i.e. to compile a history of requested information for a particular user, or the like. Accordingly, the processor may be configured to verify whether or not such code is registered on the particular central server and, if the code is not so registered, to register such code on the central server. In addition, the processor may be configured to receive a registration questionnaire with the formatted information delivered into the e-mail inbox of the computer.

The processor may be configured to receive the information as a conventional e-mail via the conventional e-mail delivery port. Otherwise, the processor may be configured to receive the information via the specific dedicated network access port not associated with a conventional e-mail delivery access port, i.e. the information is received via an Internet protocol port, or the like.

The processor may receive the information from the central server. Otherwise, the processor may receive the information from any server hosting such specific information.

It is to be appreciated that the received information uniquely associated with the relayed e-mail may include a notification to the effect that particular information is not available and/or a list of available information, e.g. an error message stating that certain information is not available as specified by the specific electronic address, or the like. It is also to be appreciated that the received information may include a list or directory of information available on a particular domain, e.g. “F350@ford.com” has no information available, but a list of information available on the “ford.com” domain, or the like.

Similarly, the received information uniquely associated with the relayed e-mail may include search results based on the specific electronic address of the identifying information which results indicate the information available, e.g. a list of information available on a certain domain name, or the like.

The processor may be configured to format the received information as an e-mail for viewing by an e-mail software application installed on the computer. The processor may be configured to format received the information into a particular format for viewing with specific software installed on the computer. Accordingly, the processor may be configured to display the formatted information on a display of the computer, i.e. the specific instructions include instructions for displaying the formatted information.

The processor may further be configured to prompt the user to specify the particular format in which the information must be displayed.

According to a second aspect of the invention there is provided a method for information delivery which method includes the following steps

automatically determining when a user sends an e-mail from a computer;

electronically prompting the user to specify a delivery method for such e-mail before said e-mail is sent via a communications network;

relaying the e-mail together with identifying information to a particular central server on the communications network via a specific dedicated network access port of the computer not associated with a conventional e-mail delivery access port of the computer if the user specifies such delivery, or relaying the e-mail via a conventional e-mail delivery port of the computer if such delivery is specified;

receiving information uniquely pre-associated with the relayed e-mail via the dedicated network access port; and

formatting the received information into a suitable format for delivery into an e-mail inbox of the computer, so that such information is requestable and/or deliverable as an e-mail independent from the conventional e-mail delivery port of the computer.

It is to be appreciated that the conventional e-mail delivery ports of a computer are generally subject to different filters than other network access ports of a computer, i.e. an Internet access port generally uses a different protocol to send and receive information. For example, a typical e-mail protocol is POP3 (Post Office Protocol 3) or SMTP (Simple Mail Transfer Protocol), and a typical Internet protocol is HTTP (Hyper Text Transfer Protocol), FTP (File Transfer Protocol), or the like.

Accordingly, by being able to send and receive information via e-mails independently of filtered and/or firewalled access ports ensures that requested information reaches an intended recipient, whilst simultaneously incorporating the efficiency and functionality of e-mail.

The step of determining when a user sends an e-mail may include monitoring a software application which facilitates the sending and receiving of e-mail messages. The monitoring may be accomplished with a suitable software application.

The step of electronically prompting the user to specify a delivery method may include displaying a suitable prompt on a display of the computer which enables the user to choose a delivery option, or the like. It is to be appreciated that the step of prompting allows the user to choose between the delivery method of relaying the e-mail and identifying information via a specific dedicated network access port of the computer not associated with a conventional e-mail delivery access port of the computer, or relaying the e-mail via a conventional e-mail delivery port of the computer if such delivery is specified.

It is to be appreciated that the e-mail is generally addressed to a particular address which is uniquely associated with specific information in which the user is interested. The specific information is typically information hosted on a website, or the like, e.g. a specific website for a particular product, or the like.

The step of relaying the e-mail together with the identifying information may include transmitting the e-mail and identifying information via the network with a suitable transmitter. It is to be appreciated that the transmitter typically includes a network interface device, or the like.

The identifying information may include locating information which allows the computer to be located on the communications network, i.e. an e-mail address, an IP (Internet Portal) address, or the like. It is to be appreciated that the locating information allows a server to send the computer the requested information via the communications network, i.e. to locate the computer on the network in order to send the requested information to the correct computer.

The identifying information may include a specific electronic address uniquely associated with specific information on the communications network, e.g. an e-mail address, an IP address, and/or the like. As such, the specific electronic address may be that of the particular central server to which the e-mail and identifying information is relayed to.

The identifying information may include a code able to identify the user sending the e-mail, e.g. personal particulars, or the like. The code may be used for research purposes, i.e. to compile a history of requested information for a particular user, or the like. Accordingly, the method may include the step of verifying whether or not such code is registered on the particular central server and, if the code is not so registered, to register such code on the central server. In addition, the method may include the step of including a registration questionnaire with the formatted information for delivery into the e-mail inbox of the computer.

The step of receiving the information may include receiving the information as a conventional e-mail via the conventional e-mail delivery port. The step of receiving the information may include receiving the information via the specific dedicated network access port not associated with a conventional e-mail delivery access port, i.e. the information is received via an Internet protocol port, or the like.

The step of receiving the information may include receiving the information from the central server. Otherwise, the step of receiving the information may include receiving the information from a server hosting such information.

It is to be appreciated that the received information uniquely associated with the relayed e-mail may include a notification to the effect that particular information is not available and/or a list of available information, e.g. an error message stating that certain information is not available as specified by the specific electronic address, or the like. It is also to be appreciated that the received information may include a list or directory of information available on a particular domain, e.g. “F350@ford.com” has no information available, but a list of information available on the “ford.com” domain, or the like.

Similarly, the received information uniquely associated with the relayed e-mail may include search results based on the specific electronic address of the identifying information which results indicate the information available, e.g. a list of information available on a certain domain name, or the like.

The step of formatting the received information may include formatting the information as an e-mail for viewing by an e-mail software application installed on the computer. The step of formatting may include formatting the information into a particular format for viewing with specific software installed on the computer. Accordingly, the method may include the further step of displaying the formatted information on a display of the computer.

The method may also include the further step of prompting the user to specify the particular format in which the information must be displayed.

According to a third aspect of the invention there is provided a computer system for information delivery which computer system includes

a memory arrangement for storing specific instructions;

a processor arranged in communication with said memory arrangement which processor executes the specific instructions in order to automatically recognize an e-mail address when entered into an address bar or tool bar of an existing network browser or a search engine input box of a computer, to relay the e-mail address together with identifying information to a particular central server on a communications network, to receive information uniquely pre-associated with the relayed e-mail address via the communications network, and to display the received information in a window of the network browser; and

a suitable transceiver with which the processor is able to relay and receive data via the communications network, so that the information associated with the e-mail address is requestable and deliverable into the browser of the computer.

The processor may relay the e-mail address and identifying information in a format not conventionally associated with web browsers, e.g. web browsers typically uses HTTP or FTP format, but the address and information may be relayed in a different format such as SMTP, POP3, or the like.

The identifying information may include locating information which allows the computer to be located on the communications network, i.e. an e-mail address, an IP (Internet Portal) address, or the like. It is to be appreciated that the locating information allows a server to send the computer the information associated with the e-mail address via the communications network.

The identifying information may include a specific electronic address uniquely associated with specific information on the communications network, e.g. an e-mail address, an IP address, and/or the like. As such, the specific electronic address may be that of the particular central server to which the e-mail and identifying information is relayed to.

The identifying information may include a code able to identify a user entering the e-mail address into the address bar, e.g. personal particulars, or the like. It is to be appreciated that this code may be contained in a software cookie, or the like. The code may be used for research purposes, i.e. to compile a history of requested information for a particular user, or the like. Accordingly, the processor may receive data uniquely associated with the code, e.g. an electronic registration form or similar data gathering form associated with the user entering the e-mail address, or the like. It is to be appreciated that the electronic registration form may be used to conduct market research, as a profile is compilable according to personal particulars of the user together with the type of information received by him/her.

The processor may receive the information from the central server. Otherwise, the processor may receive the information from a server hosting such specific information.

The processor may receive the information as a conventional e-mail into an e-mail inbox for display in the browser, or the like. Otherwise, the processor may receive the information directly into a window of the web browser, or the like.

The processor may display the received information by first formatting the received information into a suitable format, or the like. It is to be appreciated that this formatting is able to amplify any viewing capabilities of the browser.

The information uniquely pre-associated with the e-mail address may include information hosted on a computer connected to the communications network. The information uniquely pre-associated with the e-mail address may include a directory indicating information retrievable from the server via conventional information retrieval techniques.

According to a fourth aspect of the invention there is provided a method for information delivery which method includes the following steps

automatically recognizing an e-mail address when entered into an address bar or tool bar of an existing network browser or a search engine input box of a computer;

relaying the e-mail address together with identifying information to a particular central server on a communications network;

receiving information uniquely pre-associated with the relayed e-mail address via the communications network; and

displaying the received information in a window of the network browser.

The step of recognizing the e-mail address may be accomplished with a suitably configured software application configured to monitor inputs to the address or tool bar of the browser or the input box. It is to be appreciated that an e-mail address has a specific format which is able to be recognized, e.g. “john@yahoo.com”, or the like.

The step of relaying the e-mail address and identifying information may include transmitting the e-mail and identifying information via the network with a suitable transmitter. It is to be appreciated that the transmitter typically includes a network interface device, or the like.

The step of relaying the e-mail address and identifying information may include transmitting such in a format not conventionally associated with web browsers, e.g. web browsers typically uses HTTP or FTP format, but the address and information may be relayed in a different format such as SMTP, POP3, or the like.

The identifying information may include locating information which allows the computer to be located on the communications network, i.e. a second e-mail address, an IP (Internet Portal) address, or the like. It is to be appreciated that the locating information allows a server to send the computer the information associated with the e-mail address via the communications network.

The identifying information may include a specific electronic address uniquely associated with specific information on the communications network, e.g. an e-mail address, an IP address, and/or the like. As such, the specific electronic address may be that of the particular central server to which the e-mail and identifying information is relayed to.

The identifying information may include a code able to identify a user entering the e-mail address into the address bar, e.g. personal particulars, or the like. It is to be appreciated that this code may be contained in a software cookie, or the like. The code may be used for research purposes, i.e. to compile a history of requested information for a particular user, or the like. Accordingly, the step of receiving may include receiving data uniquely associated with the code, e.g. an electronic registration form or similar data gathering form associated with the user entering the e-mail address, or the like. It is to be appreciated that the electronic registration form may be used to conduct market research, as a profile is compilable according to personal particulars of the user together with the type of information received by him/her.

The step of receiving the information may include receiving the information from the central server. Otherwise, the step of receiving the information may include receiving the information from a server hosting such information.

The step of receiving the information may include receiving the information as a conventional e-mail into an e-mail inbox for display in the browser, or the like. Otherwise, the step of receiving the information may include receiving the information into a window of the web browser, or the like.

The step of displaying the received information may include first formatting the received information into a suitable format, or the like. It is to be appreciated that this formatting is able to amplify any viewing capabilities of the browser.

The information uniquely pre-associated with the e-mail address may include information hosted on a computer connected to the communications network. The information uniquely pre-associated with the e-mail address may include a directory indicating information retrievable from the server hosting such information via conventional information retrieval techniques.

### BRIEF DESCRIPTION OF THE DRAWINGS

The invention is now described, by way of non-limiting examples, with reference to the accompanying drawings wherein

FIG. 1 shows, in diagrammatic view, a method for information delivery, in accordance with the invention;

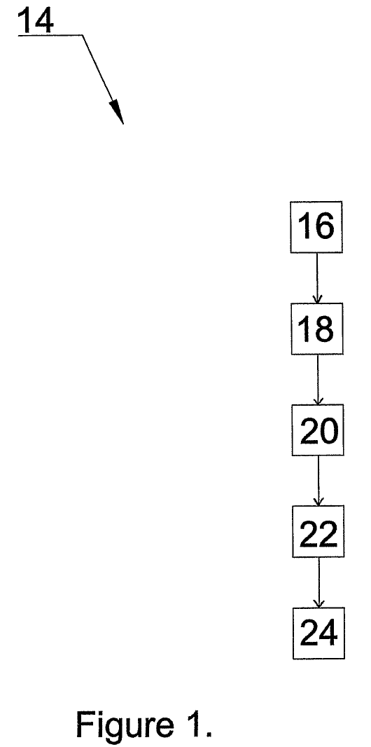

FIG. 2 shows, in schematic view, a system for information delivery, in accordance with the invention; and

FIG. 3 shows, in diagrammatic view, a method for information delivery, in accordance with the invention.

### DETAILED DESCRIPTION OF THE INVENTION

With reference to the accompanying drawings, a method for information delivery, in accordance with the invention, is generally indicated by reference numeral 14, and an associated system for information delivery, in accordance with the invention, is generally indicated by reference numeral 26.

The method 14 for information delivery, as shown, comprises the steps of determining 16, prompting 18, relaying 20, receiving 22, and formatting 24.

The step of automatically determining 16 comprises determining when a user sends an e-mail from a computer. This step of determining 16 when a user sends an e-mail is generally accomplished through monitoring an e-mail software application which facilitates the sending and receiving of e-mail messages. This monitoring in itself is typically achieved with a suitable software application, e.g. a software plug-in application installed on a computer to enhance the e-mail software application, or the like.

The step of electronically prompting 18 the user to specify a delivery method for such e-mail is done before said e-mail is sent via a communications network, such as the Internet, or the like. The step of electronically prompting 18 the user to specify a delivery method includes displaying a suitable prompt on a display of a computer which enables the user to choose a delivery option, or the like. For example, a pop-up window is displayed when a user clicks on a “send” button of an e-mail, or the like.

The step of relaying 20 the e-mail together with identifying information to a particular central server on the communications network is done via a specific dedicated network access port of the computer not associated with a conventional e-mail delivery access port of the computer if the user specifies such delivery. Otherwise, where the user specifies conventional delivery of the e-mail, the e-mail is relayed 20 to a conventional e-mail delivery port of the computer.

It is to be appreciated that the e-mail is generally addressed to a particular address which is uniquely associated with specific information in which the user is interested. The specific information is typically information hosted on a website by a server, or the like, e.g. a specific website for a particular product, or the like.

The step of relaying 20 the e-mail together with the identifying information includes transmitting the e-mail and identifying information via the network with a suitable transmitter. It is to be appreciated that the transmitter typically includes a network interface device, such as a modem, or the like.

In one embodiment of the invention, the step of receiving 22 the information which is uniquely associated with the relayed e-mail via the communications network includes receiving the information as a conventional e-mail via the conventional e-mail delivery port. In a preferred embodiment, the step of receiving 22 the information includes receiving the information via the specific dedicated network access port not associated with a conventional e-mail delivery access port, i.e. the information is received via an Internet protocol port, or the like. It is to be appreciated that this bypasses e-mail filtering, and the like.

Accordingly, the step of receiving 22 the information includes, in one embodiment, receiving 22 the information from the central server. Otherwise, in another embodiment, the step of receiving 22 the information includes receiving the information from a server hosting such information, i.e. the e-mail request and locating information is relayed from the central server to another server hosting the requested information.

It is to be appreciated that the identifying information relayed along with the e-mail includes locating information which allows a computer from which the e-mail is sent to be located on the communications network, i.e. an e-mail address, an IP (Internet Portal) address, or the like. It is further to be appreciated that the locating information so included allows a server on the communications network to send the computer the requested information via such a communications network.

In addition, the identifying information typically includes a specific electronic address uniquely associated with specific information on the communications network, e.g. an e-mail address, an IP address, and/or the like. As such, the specific electronic address may be that of the particular central server to which the e-mail and identifying information is relayed to.

For example, a specific electronic address is associated with specific product information hosted on a server on the network, e.g. information about a specific vehicle in which a user is interested, or the like. An example of such a specific electronic address is an e-mail address uniquely associated with a webpage including particular information, e.g. “F350@ford.com” relates to a webpage describing a certain motor vehicle. In this example, “F350” specifies the particular information being requested, while the “@ford.com” refers to the domain or server hosting the information.

In use, a user of the system would be able to send an e-mail, as described above, to the domain server hosting the webpages and the e-mail would identify specific pages the user is interested in accessing. The system would then retrieve these pages from the relevant web server and send the information to the user without the user having to visit the website to search for the specific information. Such a method as described would significantly reduce the user's effort in obtaining information from a website. In effect, the method of the invention allows remote collection of such the Internet content. In addition, the user will further benefit from having the information in an e-mail format for simple distribution to other e-mail recipients and having the information saved in the user's inbox to refer to at any time.

In a further embodiment of the invention, the identifying information also includes a code able to identify the user sending the e-mail, e.g. personal particulars, or the like. The code is typically used for research purposes, i.e. to compile a history of requested information for a particular user, or the like. It is to be appreciated that such a code can be stored as a cookie on a computer, or the like. Accordingly, the method may include the step of verifying whether or not such code is registered on the particular central server and, if the code is not so registered, to register such code on the central server. In addition, the method may include the step of including a registration questionnaire with the formatted information for delivery into the e-mail inbox of the computer when it has been determined that the code is not registered, or the like.

It is further to be appreciated that the conventional e-mail delivery ports of a computer are generally subject to different filters than other network access ports of a computer, i.e. an Internet access port generally uses a different protocol to send and receive information. For example, a typical e-mail protocol for receiving e-mail is POP3 (Post Office Protocol 3) and for sending e-mail is SMTP (Simple Mail Transfer Protocol), and a typical Internet protocol is HTTP (Hyper Text Transfer Protocol), FTP (File Transfer Protocol), or the like.

Accordingly, by being able to send and receive information via e-mails independently of filtered and/or firewalled e-mail access ports ensures that requested information reaches an intended recipient, whilst simultaneously incorporating the efficiency and functionality of e-mail.

Accordingly, the step of formatting 24 the received information into a suitable format for delivery into an e-mail inbox of the computer allows that such information is requestable and/or deliverable as an e-mail independent from the conventional e-mail delivery port of the computer. The step of formatting 24 the received information includes formatting the information as an e-mail for viewing by an e-mail software application installed on the computer. Otherwise, in a further embodiment, the step of formatting 24 includes formatting the information into a particular format for viewing with specific software installed on the computer, e.g. a plug-in application to an e-mail program, or the like.

It is to be appreciated that the method 14 may also include the further step of displaying the formatted information on a display of the computer. In addition, the method 14 may include the step of prompting the user to specify the format in which the information is to be displayed.

It is further to be appreciated that the above method steps are generally performed as software instructions in a suitably configured computer system.

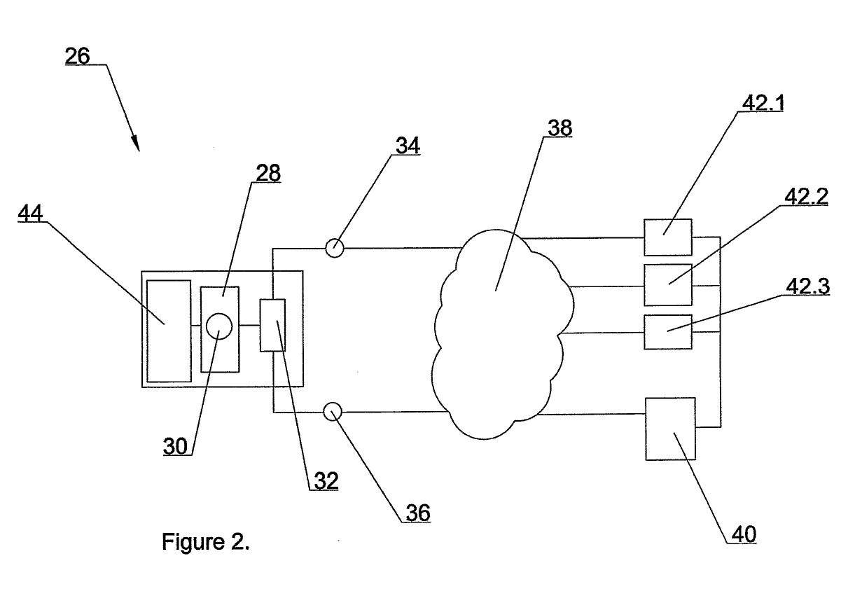

Accordingly, with reference to FIG. 2, this Invention includes a computer system 26 for information delivery, which computer system 26 includes a memory arrangement 28, a processor 30, a display 44, a transceiver 32 managing sending and receiving ports 34 and 36. The system is arranged in communication with a communications network 38, such as the Internet, or the like. It is to be appreciated that the system 26 is associated with the method 14 described above.

Accordingly, other domain servers 42 are also connected to the network, as well as a central server 40 in one embodiment of the invention.

The memory arrangement 28 is for storing specific instructions. As such, the memory arrangement includes any suitable memory storage, such as magnetic memory storage, optical storage, and/or the like.

The processor 30 is arranged in communication with said memory arrangement 28, as shown. The processor 30 is configured to execute the specific instructions stored in the memory arrangement 28 in order to automatically determine when a user sends an e-mail from the computer system 26.

The processor also executes specific instructions to electronically prompt the user to specify a delivery method for such e-mail before said e-mail is sent via the communications network 38, to relay the e-mail together with identifying information to a particular central server 40 and/or domain server 42 on the communications network via a specific dedicated network access port 34 of the computer not associated with a conventional e-mail delivery access port 36 of the computer if the user specifies such delivery. Otherwise, if the user specifies conventional e-mail delivery, the processor 30 relays the e-mail to the conventional e-mail delivery port 36 of the computer. It is to be appreciated that the conventional port is subject to e-mail filtering, and the like.

The processor also executes the instructions in order to receive information uniquely associated with the relayed e-mail via the dedicated network access port 34, and to format the received information into a suitable format for delivery into an e-mail inbox of the computer 26.

As mentioned, the system 26 includes a suitable transceiver 32 with which the processor 30 is able to relay and receive data via the communications network 38, so that the information associated with the address is requestable and/or deliverable as an e-mail independent from the conventional e-mail delivery port 36 of the computer.

Once the processor 30 has established that an e-mail is being sent from the computer 26, the processor 30 prompts the user to specify a delivery method by typically displaying a suitable prompt on the display 44 of the computer 26 to enable the user to choose an option, or the like.

The processor 30 may be configured to receive the information associated with the e-mail as a conventional e-mail via the conventional e-mail delivery port 36. Otherwise, the processor 30 may also be configured to receive the information via the specific dedicated network access port 34 not associated with the conventional e-mail delivery access port 36, i.e. the information is received via an Internet protocol port, or the like.

Accordingly, the processor 30 may receive the information from the central server 40. Otherwise, the processor 30 may receive the information from any domain server 42 hosting such specific information.

The processor 30 is typically configured to format the received information as an e-mail for viewing by an e-mail software application installed on the computer 26. The processor 30 may also be configured to format the received information into a particular format for viewing with specific software installed on the computer 26. Accordingly, the processor 30 is generally configured to display the formatted information on the display 44 of the computer 26, i.e. the specific instructions include instructions for displaying the formatted information.

In use, in one embodiment of the invention, the specific instructions in the memory arrangement 28 form a software application installed as a plug-in to enhance the features of an existing e-mail application. This allows the ability to send an e-mail to request web content, i.e. the information uniquely associated with the relayed e- mail, into an e-mail application from a web site hosted by a domain server 42. This plug-in installed in the existing e-mail application then has the ability to access the domain server 42 containing the web pages, retrieve the web pages, compile the content into an e-mail message and insert the e-mail into the users inbox without sending the e-mail through SMTP or similar e-mail protocol.

When a user of the e-mail application sends an e-mail, the processor 30 prompts the user for his sending option or delivery choice. At this point, the user decides whether he is sending an e-mail to access information from a website hosted by a domain server 42 which he would like to be sent to his inbox as an e-mail, or whether he is sending a conventional e-mail communication.

In one embodiment, if the user chooses to send a conventional e-mail, the processor 30 uses conventional e-mail SMTP protocol using port 25 of the computer. This transmits the e-mail through various conventional e-mail servers to the designated e-mail account indicated by a unique e-mail address. Similarly, returning e-mails via conventional e-mail channels are typically retrieved by the e-mail application using Post Office Protocol (POP3) on port 110 of the computer.

It is to be appreciated that these ports mentioned above, i.e. ports 25 and 110, are conventionally associated with conventional e-mail delivering and are subject to e-mail filtering, and the like.

If the user decides that he is sending an e-mail with the intention of using his e-mail application to retrieve and/or request webpage content hosted by a domain server 42 for delivery to his e-mail inbox, the processor 30 relays the e-mail via the dedicated network access port 34 not associated with e-mail deliveries. Such a port not associated with e-mail deliveries may include any open connection to the network or Internet available on the computer, such as port 80 which is generally configured for Internet protocol connections, or a particular dedicated port, or the like.

It is to be appreciated that processor 30 may relay the e-mail to the central server 40 which is configured to recognize the e-mail address uniquely associated with the requested information, which server 40 then relays the identifying information to the specified domain server 42, which hosts the identified information. Otherwise, the processor 30 may relay the e-mail and identifying information directly to the indicated domain server 42.

It is further to be appreciated that, where the central server 40 is involved, market research may be conducted in this process.

Central server 40 typically contains a database of registered clients and domains. If the processor 30 relays the e-mail and identifying information to the central server 40, this server 40 is able to identify the specific electronic address associated with specific information e.g. “F350@ford.com” and the domain name, e.g. “ford.com” to search within its database to check whether “ford.com” is a registered user of the system. If “ford.com” is not registered, it would send a notification to the processor 30 to display a message on the display to inform the user that the message could not be delivered or a connection could not be made and offer the user the option to transmit his message via the normal SMTP port 36.

If the central server 40 identifies that the domain e.g. “ford.com” is a registered user of the system, it would relay the request to the relevant domain server 42. The central server 40 will also identify the user's return e-mail address, e.g. “john@yahoo.com”, and access a database of registered customers to identify whether “john@yahoo.com” has registered to make use of the service. If the user's e-mail address has been registered it would send the registration details to the relevant domain server 42, e.g. the “ford.com” server and register the user with the Ford registration database. If the user has not been registered, the central server 40 database would inform the relevant server, e.g. ford.com that the user is not registered and include a registration page and/or process in the return information sent to the computer 26 to allow the user of “john@yahoo.com” to register on the system.

The information received by the computer from the relevant server may contain a complete e-mail or the source code for the e-mail content. Having the source code, the processor 30 would be configured to compile the e-mail with the received information sent by the relevant server, and immediately insert the e-mail into the inbox of the user's e-mail application.

Otherwise, the e-mail content may also be compiled in HTML format, or compiled and delivered to the inbox in any number of formats, such as TXT (Text), Interactive flash content, or the like. The content may also be embedded in the e-mail which is delivered so as to download certain content from the Internet when the user opens the e-mail. Otherwise, the system 26 may be configured to view specialized formats of content.

It is to be appreciated that the method 14 above includes a registration process to verify that a user is registered to use the system 26, which automatically verifies the registration of the sender. If the user is not registered, the method 14 and associated system 26 allows the user to complete a registration process that is delivered with requested information into the user's inbox.

In addition, the system 26 and method 14 also generally includes a verification and search facility. When the users chooses to send an e-mail using the present invention to access a web server or a central server hosting information that the user would like to retrieve, the sending process will first identify the domain in the send e-mail, e.g. “@ford.com” and then determine if this domain is registered on an associated central 42 or central server 40. The verification process will also determine the availability of the information before the “@” sign, e.g. in the format “product@registered domain” to determine if the information is available on the system. If not, the system will display a directory of valid information available for retrieval.

Similarly, the search facility included allows a user to search a domain registered on the system 26 by simply typing a relevant search query programmed into the system, which is stored as a function of system 26 by the processor 30. For instance the user may type “@ford.com” in delivery means of sending and receiving port 34 and send this request as a search request. The search facility will access the ford.com server and retrieve a directory listing of products available on the domain server for retrieval. In a further embodiment, the search display facility may also arrange the search results into categories of product as specified by the domain server for delivery as an e-mail, or the like.

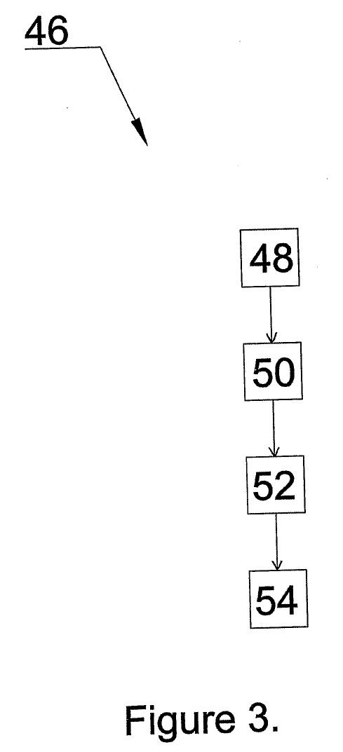

With reference now to FIG. 3, this Invention also provides for a further method 46 for information delivery which includes the steps of recognizing 48 an e-mail address, relaying 50 the e-mail address, receiving 52 information, and displaying 54 the information.

The step of automatically recognizing 48 an e-mail address is done when an address is entered into an address bar of an existing network browser of a computer. The step of recognizing the e-mail address is generally accomplished with a suitably configured software application configured to monitor inputs to the address bar of the browser. It is to be appreciated that an e-mail address has a specific format which is able to be recognized, e.g. “john@yahoo.com”, or the like.

It is to be appreciated that e-mail address may be entered into an address bar of a browser, or a web browser tool bar, or a search engine input box, or an instant messenger service, or the like. Accordingly, it is to be appreciated that the method to identify an e-mail address and execute the functions of the system as described above, to access relevant pages that are assigned to an e-mail address can be integrated into any internet enabled application where a user can derive the benefit of the system. As such, only the embodiment utilizing the address bar is described, but it must be appreciated that the following description is equally applicable to the above-mentioned applications.

The step of relaying 50 the e-mail address together with identifying information to a particular central server on a communications network includes transmitting the e-mail and identifying information via the network with a suitable transmitter. It is to be appreciated that the transmitter typically includes a network interface device, or the like.

Similar to the above, the identifying information includes locating information, a specific electronic address uniquely associated with specific information on the communications network, and a code able to identify a user entering the e-mail address into the address bar, e.g. personal particulars, or the like.

It is to be appreciated that this code is typically contained in a software cookie, or the like. The code finds particular application for research purposes, i.e. to compile a history of requested information for a particular user, or the like. Accordingly, in one embodiment of the invention, the step of receiving 52 includes receiving data uniquely associated with the code, e.g. an electronic registration form or similar data gathering form associated with the user entering the e-mail address, or the like. It is to be appreciated that such an electronic registration form is generally used to conduct market research, as a profile is compilable according to personal particulars of the user together with the type of information received by him/her.

The step of receiving 52 includes receiving information uniquely associated with the e-mail address relayed via the communications network. As such, the step of receiving the information may include receiving the information from the central server, or receiving the information from a server hosting such information, or the like.

In addition, the step of receiving 52 the information may include receiving the information as a conventional e-mail into an e-mail inbox for display in the browser, or receiving the information into a window of the web browser, or the like.

The step of displaying 54 the received information in a window of the network browser typically includes first formatting the received information into a suitable format, or the like. It is to be appreciated that this formatting is able to amplify any viewing capabilities of the existing browser, as content not conventionally viewable with a browser may be viewable in the browser when so formatted.

The Invention accordingly further provides for a computer system for information delivery associated with the above method 46. Similarly to the system shown in FIG. 2, the computer system includes a memory arrangement, a processor and a suitable transceiver.

The memory arrangement 28 is for storing specific instructions, e.g. a software application, a computer program, or the like.

The processor 30 is arranged in communication with said memory arrangement 28, with the processor 30 being configured to execute the specific instructions in order to automatically recognize an e-mail address when entered into an address bar of an existing network browser of the computer 26, to relay the e-mail address together with identifying information to a particular central server on a communications network 38, to receive information uniquely associated with the relayed e-mail address via the communications network 38, and to display the received information in a window of the network browser.

The system 26 also includes a suitable transceiver 32 with which the processor 30 is able to relay and receive data via the communications network 38, so that the information associated with the e-mail address is requestable and deliverable into the browser of the computer.

As above, the identifying information may include locating information, a specific electronic address uniquely associated with specific information, and a code able to identify a user entering the e-mail address into the address bar.

The code is typically used for research purposes, i.e. to compile a history of requested information for a particular user, or the like. Accordingly, the processor 30 then receives data uniquely associated with the code, e.g. an electronic registration form or similar data gathering form associated with the user entering the e-mail address, or the like. It is to be appreciated that the electronic registration form may be used to conduct market research, as a profile is compilable according to personal particulars of the user together with the type of information received by him/her.

It is to be appreciated that the processor 30 may receive the information from the central server 40 or from a domain server 42 hosting such specific information.

In addition, the processor 30 may receive the information as a conventional e-mail into an e-mail inbox for display in the browser, or directly into a window of the web browser, or the like.

The processor 30 typically displays the received information by first formatting the received information into a suitable format, or the like. It is to be appreciated that this formatting is able to amplify any viewing capabilities of the browser, i.e. enhanced content is viewable, and the like.

In use, a user types an e-mail address into the address bar of a web browser, so that the application in the form of the specific instructions takes over such a request, bypasses the HTTP protocol for accessing web pages, and deals with the process of accessing the relevant server, as described above, and displays the content in the web browser.

As such, it is to be appreciated that such an application could be installed as a plug-in to any web browser, any browser application, or any internet enabled application on a computer. With the application installed, an individual who has registered to make use of the service would be able to access specific web content assigned with unique e-mail addresses directly from their web browser plug-in.

In general, when an input is typed into the address bar of any web browser, the default settings of the web browser are to make use of HTTP protocol to access the web page. Generally, even when a web address is typed without inserting HTTP before the URL (Uniform Resource Locator), the web browser will automatically assume a HTTP protocol. It is to be appreciated that there are additional protocols available when using the address bar, such as FTP (File Transfer Protocol), which could relay information directed at a particular site or domain for specialized access directly to web servers.

In a further example of the system 26, the information uniquely pre-associated with the e-mail address may include information hosted on a server or computer connected to the communications network, e.g. a person is then able to associate specific information on his/her computer with a specific e-mail address. Another person is then able to send an e-mail identifying this hosted information and the system 26 then provides this person with remote access to this hosted information according to the system described above.

For example, an attorney can assign specific client documents hosted on his computer to a unique e-mail address using a suitable application according to the invention, e.g. client@brainmail.com, such as contracts for that client, invoices for that client, and the like. The client can then send an e-mail to the attorney and the system according to the invention recognizes the e-mail address (client@brainmail.com) and displays the so assigned documents in a browser of the client. The client is then able to access these documents in a secure manner.

If the attorney's computer is offline, for example, the system may only display a directory of hosted pre-associated information, e.g. a list, or the like. In another embodiment, the information so associated may be transferred to the central server to allow the client access to the information even in the event where the attorney's computer is offline, or the like.

Although only certain embodiments of the invention have been described herein, it will be understood by any person skilled in the art that other modifications, variations, and possibilities of the invention are possible. Such modifications, variations and possibilities are therefore to be considered as falling within the spirit and scope of the invention and hence forming part of the invention as herein described and/or exemplified.

It shall be understood that the examples are provided for illustrating the invention further and to assist a person skilled in the art with understanding the invention and is not meant to be construed as unduly limiting the reasonable scope of the invention.

The Inventor regards it as an advantage that the Invention enables a user to request and receive information with the efficiency and ease of a conventional e-mail whilst not being subject to filtering of such communication. The Inventor regards it as a further advantage that the Invention allows a user to obtain specific information without requiring lengthy Internet searches.

The Inventor regards it as a further advantage that the Invention enables information requested by a user to be delivered without the possible delay associated with conventional e-mail methods. The Inventor regards it as a further advantage that the Invention enables the viewing of specific content in a preferred format within an easy-to-use application such as an e-mail application.

1. A computer system for information delivery, which computer system includes a memory arrangement for storing specific instructions;
a processor arranged in communication with said memory arrangement which processor executes the specific instructions, in use, in order to automatically determine when a user sends an e-mail from the computer, to electronically prompt the user to specify a delivery method for such e-mail before said e-mail is sent via a communications network, to relay the e-mail together with identifying information to a particular central server on the communications network via a specific dedicated network access port of the computer not associated with a conventional e-mail delivery access port of the computer if the user specifies such delivery, or to relay the e-mail via a conventional e-mail delivery port of the computer if such delivery is specified, to receive information uniquely pre-associated with the relayed e-mail via the dedicated network access port, and to format the received information into a suitable format for delivery into an e-mail inbox of the computer; and
a suitable transceiver with which the processor is able to relay and receive data via the communications network, so that the information associated with the address is requestable and/or deliverable as an e-mail independent from the conventional e-mail delivery port of the computer.

2. A system as claimed in claim 1, wherein the processor is configured to prompt the user to specify a delivery method by displaying a suitable prompt on a display of the computer which enables the user to choose an applicable option.

3. A system as claimed in claim 1, wherein the identifying information includes locating information which allows the computer to be located on the communications network to allow the server to send the computer the requested information via the communications network.

4. A system as claimed in claim 1, wherein the identifying information includes a specific electronic address uniquely pre-associated with specific information hosted on the communications network.

5. A system as claimed in claim 1, wherein the identifying information includes a code able to identify the user sending the e-mail.

6. A system as claimed in claim 5, wherein the code is useable for research purposes in allowing a server to compile a history of requested information for a particular user.

7. A system as claimed in claim 5, wherein the processor is configured to verify whether or not such code is registered on the particular central server and, if the code is not so registered, to register such code on the central server.

8. A system as claimed in claim 7, wherein the processor is configured to receive a registration questionnaire from the central server together with the receiver information prior to formatting the information for delivery into the e-mail inbox of the computer.

9. A system as claimed in claim 1, wherein the processor receives the information from the central server.

10. A system as claimed in claim 1, wherein the processor receives the information from any server arranged in communication with the communications network hosting such specific information.

11. A system as claimed in claim 1, wherein the received information uniquely pre-associated with the relayed e-mail includes a notification to the effect that particular information is not available and/or a directory list of information that is available.

12. A system as claimed in claim 1, wherein the processor is configured to format the received information as an e-mail for viewing by an e-mail software application installed on the computer.

13. A system as claimed in claim 1, wherein the processor is configured to format the received information into a particular format for viewing with specific software installed on the computer.

14. A method for information delivery which method includes the following steps
automatically determining when a user sends an e-mail from a computer;
electronically prompting the user to specify a delivery method for such e-mail before said e-mail is sent via a communications network;
relaying the e-mail together with identifying information to a particular central server on the communications network via a specific dedicated network access port of the computer not associated with a conventional e-mail delivery access port of the computer if the user specifies such delivery, or relaying the e-mail via a conventional e-mail delivery port of the computer if such delivery is specified;
receiving information uniquely pre-associated with the relayed e-mail via the dedicated network access port; and
formatting the received information into a suitable format for delivery into an e-mail inbox of the computer, so that such information is requestable and/or deliverable as an e-mail independent from the conventional e-mail delivery port of the computer.

15. A method as claimed in claim 14, wherein the step of determining when a user sends an e-mail includes monitoring a software application which conventionally facilitates the sending and receiving of e-mail messages.

16. A method as claimed in claim 14, wherein the identifying information includes locating information which allows the computer to be located on the communications network.

17. A method as claimed in claim 14, wherein the identifying information includes a specific electronic address uniquely associated with specific information hosted on the communications network.

18. A method as claimed in claim 14, wherein the identifying information includes a code able to identify the user sending the e-mail.

19. A method as claimed in claim 18, wherein the code is useable for research purposes allowing a server to compile a history of requested information for a particular user.

20. A method as claimed in claim 18, which includes the step of verifying whether or not such code is registered on the particular central server and, if the code is not so registered, to register such code on the central server.

21. A method as claimed in claim 20, which includes the step of including a registration questionnaire with the relayed information for delivery into the e-mail inbox of the computer.

22. A method as claimed in claim 14, wherein the step of receiving the information includes receiving the information from the central server.

23. A method as claimed in claim 14, wherein the step of receiving the information includes receiving the information from a server hosting such information.

24. A method as claimed in claim 14, wherein the received information uniquely associated with the relayed e-mail includes a notification to the effect that particular information is not available and/or a directory list of information that is available.

25. A computer system for information delivery which computer system includes
a memory arrangement for storing specific instructions;
a processor arranged in communication with said memory arrangement which processor executes the specific instructions, in use, in order to automatically recognize an e-mail address when entered into an address bar or tool bar of an existing network browser or a search engine input box of a computer, to relay the e-mail address together with identifying information to a particular central server on a communications network, to receive information uniquely pre-associated with the relayed e-mail address via the communications network, and to display the received information in a window of the network browser; and
a suitable transceiver with which the processor is able to relay and receive data via the communications network, so that the information associated with the e-mail address is requestable and deliverable into the browser of the computer.

26. A system as claimed in claim 25, wherein the processor is configured to relay the e-mail address and identifying information in a format or protocol not conventionally associated with web browsers.

27. A system as claimed in claim 25, wherein the identifying information includes locating information which allows the computer to be located on the communications network.

28. A system as claimed in claim 25, wherein the identifying information includes a specific electronic address uniquely pre-associated with specific information on the communications network.

29. A system as claimed in claim 25, wherein the identifying information includes a code able to identify a user entering the e-mail address into the address bar.

30. A system as claimed in claim 29, wherein the code is contained in a software cookie.

31. A system as claimed in claim 29, wherein the code is useable for research purposes allowing a server to compile a history of requested information for a particular user.

32. A method for information delivery which method includes the following steps
automatically recognizing an e-mail address when entered into an address bar or tool bar of an existing network browser or a search engine input box of a computer;
relaying the e-mail address together with identifying information to a particular central server on a communications network;
receiving information uniquely pre-associated with the relayed e-mail address via the communications network; and
displaying the received information in a window of the network browser.

33. A method as claimed in claim 32, wherein the step of recognizing the e-mail address is accomplished with a suitably configured software application configured to monitor inputs to the address or tool bar of the browser or the input box.

34. A method as claimed in claim 32, wherein the step of relaying the e-mail address and identifying information includes transmitting such in a format or protocol not conventionally associated with web browsers.

35. A method as claimed in claim 32, wherein the identifying information includes locating information which allows the computer to be located on the communications network.

36. A method as claimed in claim 32, wherein the identifying information includes a specific electronic address uniquely associated with specific information on the communications network.

37. A method as claimed in claim 32, wherein the identifying information includes a code able to identify a user entering the e-mail address into the address bar.

38. A method as claimed in claim 37, wherein the code is useable for research purposes allowing a server to compile a history of requested information for a particular user.

39. (canceled)

40. (canceled)
